(19) United States
(12) Patent Application Publication
(10) Pub. No.: US 2008/0256644 A1
(43) Pub. Date: Oct. 16, 2008

(54) Real-time detail information display method of digital rights management contents and portable terminal using the same

(75) Inventors: Kyung Keun Lee, Daegu Metropolitan City (KR); Yong Dae Kwon, Daegu Metropolitan City (KR)

Correspondence Address: CHA & REITER, LLC, 210 ROUTE 4 EAST STE 103, PARAMUS, NJ, 07652, US

(73) Assignee: Samsung Electronics Co., LTD.

(21) Appl. No.: 11/975,013

(22) Filed: Oct. 17, 2007

(30) Foreign Application Priority Data
Apr. 12, 2007 (KR) 2007-0035890

(51) Int. Cl. H04L 9/00

(52) U.S. Cl. 726/27

(57) ABSTRACT

A real-time detail information display method of digital rights management (DRM) contents and a portable terminal for practicing that downloads digital rights management (DRM) content information from a server, in real-time. The portable terminal extracts address information of the DRM contents indicated on the display, accesses the server based on the extracted address information, and receives the DRM content information from the server and displays it on the display.

### CLAIM OF PRIORITY

This application claims priority from an application entitled “REAL-TIME DETAIL INFORMATION DISPLAY METHOD OF DIGITAL RIGHTS MANAGEMENT CONTENTS AND PORTABLE TERMINAL USING THE SAME” filed in the Korean Intellectual Property Office on Apr. 12, 2007 and assigned Serial No. 2007-0035890, the contents of which are incorporated herein by reference in its entirety.

### BACKGROUND OF THE INVENTION

1. Field of the Invention

The present invention relates to the technology of displaying information through a portable terminal. More particularly, the present invention relates to a real-time detail information display method that downloads information related to Digital Rights Management (hereinafter referred to as DRM) contents from a server in real-time and displays it on a display screen on which the DRM contents are displayed in a list. In addition, this invention also relates to a portable terminal using the present display method.

2. Description of the Related Art

Digital rights management (DRM) refers to a means by which technologies manage and protect the intellectual property rights of digital contents using encoding technology. In other words, the DRM technologies serve to securely transmit a variety of content from a content provider (CP) to users, and to prevent users from illegally copying and circulating the variety of content. DRM technologies can protect digital contents throughout their complete lifecycle, from creation, distribution, use, to abolishment, and can protect the usage and rights of users off-line, as well as on-line.

In addition, portable terminals, which can be carried easily, are able to store an ever-increasing variety of application programs, and can reproduce a variety of data. On top of such functional advantages, portable terminals can be used in various fields. For instance, with regard to portable terminals, a mobile communication terminal permits a user to make a call without a wired connection, and such calls can even be made while in motion, such as an automobile, train, etc. Mobile communication terminal service subscribers and users continue to increase in number, particularly as the costs of owning and operating such devices continues to be reduced.

Portable terminal are typically configured to include a display that displays information, stored in the portable terminal, and information received from external devices. Such a display provides display screen interfaces that allow a user to read a variety of states of the portable terminal as well as provides basic functions, such as a control operation, a phone number input operation for a call, and a text messaging input operation.

Such a display provides access to a variety of files in a list, for example, DRM content stored in the memory. A plurality of DRM contents are displayed in a list such that they can be easily searched using file indexes. As such, the conventional display displays contents such that a user can check which DRM contents are stored in the memory of a portable terminal. Therefore, a method is required that can display a list of DRM contents stored in the memory and also allow a user to acquire a variety of information related to the DRM contents easily. In addition, since the DRM contents-related information can be changed depending on the situation of a server for providing DRM contents and on the sale of the DRM contents, etc, a method is required that permits many users to acquire updated DRM content information rapidly and easily.

### SUMMARY OF THE INVENTION

The present invention is made at least in part to solve some of the above-mentioned problems. Therefore, the present invention provides a real-time detailed information display method that downloads digital rights management (DRM) content information from a server, in real-time, and displays it on a display screen, and provides a portable terminal using this method.

In accordance with an exemplary aspect of the present invention, there is provided an information display method of digital rights management (DRM) contents, which includes: displaying a list of at least one DRM contents; extracting at least one piece of address information from the DRM contents; accessing servers that provide DRM content information that defines at least one of the features of the DRM contents and of a license of the DRM contents based on the extracted address information; receiving the DRM content information from the server; and displaying the received DRM content information on a region displaying corresponding DRM contents.

In accordance with another exemplary aspect of the present invention, there is provided a portable terminal displaying digital rights management (DRM) contents, which includes: a memory for storing at least one or more DRM contents; a display for displaying the DRM contents in a list; a radio frequency unit receiving DRM content information for defining at least one of the features of the DRM contents and of a license of the DRM contents from external devices; and a control unit for controlling a display of the DRM content information in a region displaying corresponding DRM contents.

### BRIEF DESCRIPTION OF THE DRAWINGS

The objects, features, and advantages of the present invention will be more apparent from the following detailed description in conjunction with the accompanying drawings, in which:

FIG. 1 is a schematic view depicting a real-time detail information display system of DRM contents according to an exemplary embodiment of the present invention;

FIG. 2 is a schematic view depicting a portable terminal according to an exemplary embodiment of the present invention;

FIG. 3 is a display screen displaying DRM content information according to an exemplary embodiment of the present invention;

FIG. 4 is a display screen displaying DRM content information according to another exemplary embodiment of the present invention;

FIG. 5 is a flow chart illustrating an exemplary embodiment of a real-time detail information display method of DRM contents according to the present invention;

FIG. 6 is a flow chart illustrating another exemplary embodiment of a real-time detail information display method of DRM contents according to the present invention; and

FIG. 7 is a flow chart illustrating another exemplary embodiment of a real-time detail information display method of DRM contents according to the present invention.

### DETAILED DESCRIPTION OF THE INVENTION

Hereinafter, exemplary embodiments of the present invention are described in detail with reference to the accompanying drawings. The same reference numbers are used throughout the drawings to refer to the same or like parts. Detailed descriptions of well-known functions and structures incorporated herein may be omitted to avoid obscuring the subject matter of the present invention with detail regarding such well-known functions and structures.

The terms or words described in the present description and the claims should not be limited by a general or lexical meaning, instead should be analyzed as a meaning and a concept through which the inventor defines and describes the present invention with his greatest effort, to comply with the ideas of the present invention. Therefore, one skilled in the art will understand that the exemplary embodiments disclosed in the description and configurations illustrated in the drawings are only preferred exemplary embodiments, and instead there may be various modifications, alterations, and equivalents thereof that are within the spirit of the invention and the scope of the appended claims.

In the following description, the digital rights management (DRM) content information includes license-related information of DRM contents, DRM contents-related information, and image information included in the DRM contents, etc. Here, the license-related information includes the authority-limit-related information for reproduction or display of the DRM contents, information related to license price, purchase route, and purchase method, and server address information for acquiring a license, etc. In addition, the license-related information includes at least one of: a reproduction limitation item of DRM contents, a display limitation item of DRM contents, an execution limitation item of DRM contents, a printed output limitation item of DRM contents, an external output limitation item of DRM contents, a short-range wireless communication availability limitation item of DRM contents, and an additional information item describing DRM contents. The DRM contents-related information includes: a file feature of DRM contents; use, type, size, and creation time of DRM contents; and also includes, for example, Internet address information (including but in no way limited to URL's) for downloading DRM contents, etc. The image information refers to information indicative of DRM contents. The image information may be, for example, an album cover art when the DRM contents are music, and may be, for example, a movie poster when the DRM contents are a movie. Additionally, the image information can be variously set according to the features of the DRM contents.

Although the portable terminal according to the present invention is described based on a mobile communication terminal, it will be appreciated that the portable terminal is not limited by the mobile communication terminal. Rather, the portable terminal according to the present invention can be applied to all the information communication devices, multimedia devices, and their applications, such as, a terminal including a module that can reproduce DRM contents, preferably, a mobile communication terminal, a digital broadcasting terminal, a personal digital assistant (PDA), a smart phone, a 3rd Generation (3G) terminal, such as, for example, an international mobile telecommunication 2000 (IMT-2000) terminal, a wideband code division multiple access (WCDMA) terminal, a global system for mobile communication/general packet radio service (GSM/GPRS) terminal, and a universal mobile telecommunication service (UMTS) terminal, etc.

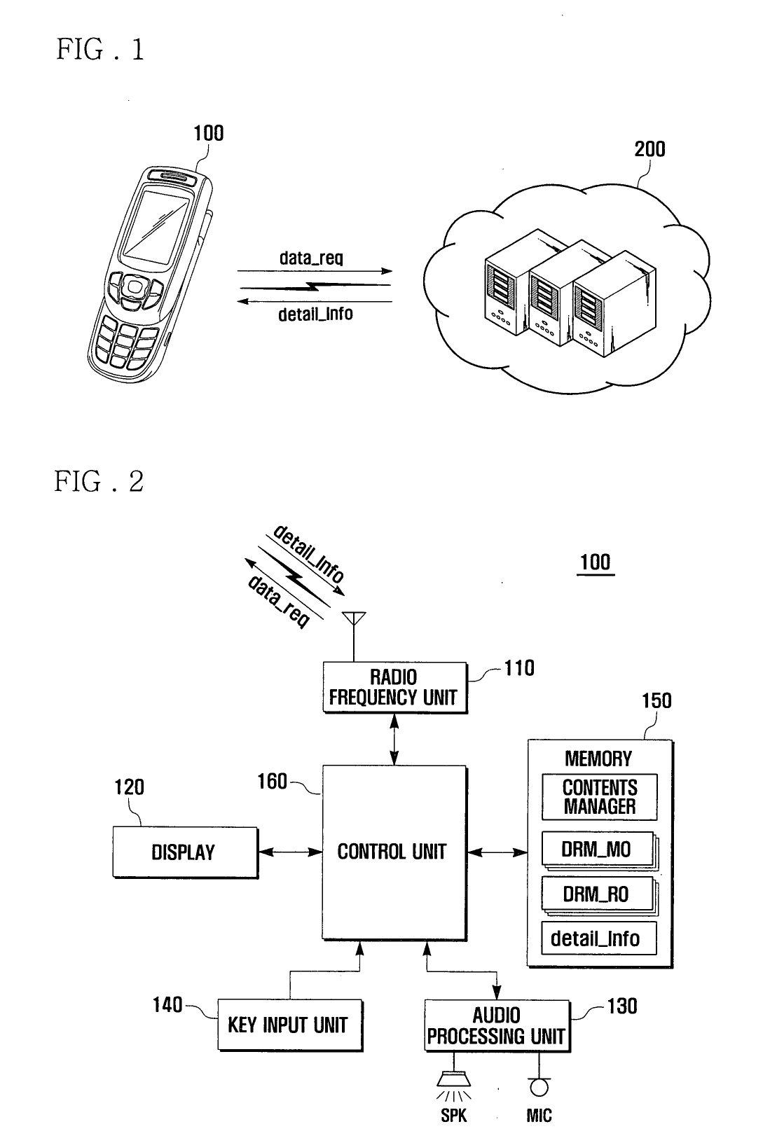

FIG. 1 is a schematic view depicting a real-time detailed information display system of DRM contents according to an exemplary embodiment of the present invention.

Now referring to FIG. 1, the real-time detail information display system includes a contents providing server 200 that provides DRM content information (detail_Info), and a portable terminal 100 that displays the DRM content information (detail_Info).

The contents providing server 200 provides DRM contents, a license for reproducing DRM contents, DRM content information (detail_Info) related to DRM contents and license of DRM contents, according to a information request message (data_req) transmitted by a portable terminal 100.

The portable terminal 100 accesses the contents providing server 200 to download the DRM contents and the license. The portable terminal 100 displays its stored DRM contents on the display in a list or a matrix form. The portable terminal transmits the information request message (data_req) which requests DRM content information (detail_Info) to the contents providing server 200. Here, the information request message (data_req) refers to a message that requests DRM content information (detail_Info) related to DRM contents, which is designated by an input signal of a key input of the portable terminal, or the total DRM contents. Meanwhile, the portable terminal 100 displays the received DRM content information (detail_Info) on the display screen.

Still referring to FIG. 1, when the portable terminal 100 displays the variety of DRM contents in a list or a matrix form, the real-time detail information display system of DMR contents, according to the present invention, downloads the DRM content information (detail_Info) of DRM contents, designated by a key input unit, or the total DRM contents from the contents providing server 200, in real time, and displays the on the display of the portable terminal 100.

The following is a detailed description of a configuration of the portable terminal according to the present invention, in conjunction with FIG. 2.

FIG. 2 is a schematic view depicting a portable terminal according to an exemplary embodiment of the present invention.

The portable terminal 100 of the present invention includes, for example, a radio frequency unit 110, a memory 150, a display 120, a key input unit 140, and a control unit 160. In addition, the portable terminal 100 may further include an audio processing unit 130.

When the portable terminal 100 is implemented as a mobile communication terminal, the radio frequency unit 110 creates a communication channel between the terminal and a base station to allow the terminals to make a voice call, or wirelessly transmits a user's data to other terminals, etc.

In addition, the radio frequency unit 110 shown in FIG. 2 performs communication operations, such as transmission and reception of contents and control signals related to the contents, associated with an external web server. The radio frequency unit 110 includes a radio frequency (RF) transmitter, which up-converts frequency of transmitted signals and amplifies the transmitted signals, and an RF receiver that performs low-noise amplification of received signals and down-converts the frequency of the received signals.

More specifically, the radio frequency unit 110 shown in FIG. 2 downloads DRM contents (DRM_MO) and a license (DRM_RO) for reproducing the DRM contents (DRM_MO) from the contents providing server 200. The radio frequency unit 110 transmits an information request message (data_req) to the contents providing server 200 (shown in FIG. 1) according to a request of the portable terminal 100, and downloads, in real time, the DRM content information (detail_Info) from the contents providing server 200.

Still referring to FIG. 2, the memory 150 stores the DRM contents (DRM_MO) and a license (DRM_RO) that limits an authority of reproduction according to DRM contents (DRM_MO). Also, the memory 150 stores a contents manager for administrating and controlling the DRM contents (DRM_MO). When a user wants to select a variety of DRM contents (DRM_MO) stored in the portable terminal 100, the memory 150 transmits the contents manager to the control unit 160. The contents manager is loaded on the control unit 160 to display the DRM contents (DRM_MO) on the display 120. The contents manager controls to display DRM content information (detail_Info) of the designated DRM contents (DRM_MO).

In addition, the contents manager controls display of DRM content information (detail_Info) related to all stored DRM contents (DRM_MO) according to a user's selection. Such a contents manager will be described later in association with the control unit 160.

The memory 150 is also sub-divided into a program region and a data region. The program region stores an operating system for initializing the portable terminal 100 and application programs for a reproduction module necessary for reproducing the DRM contents (DRM_MO), options of the portable terminal 100, such as a camera function, a sound reproducing function, and image or moving image reproducing functions, etc.

When each function is activated in response to a user's request, the portable terminal 100 provides the requested function using a corresponding application program under the control of the control unit 160. The program region of the memory 150 stores the contents manager. When the user wants to designate and select DRM contents (DRM_MO), the contents manager is loaded on the control unit 160.

The data region refers to a region storing data in the memory 150 created in the portable terminal 100, which stores the DRM contents (DRM_MO) and a license (DRM_RO) for reproducing the DRM contents (DRM_MO). Additionally, the data region may store images or moving images, photographed by a camera (an option of the portable terminal 100), phone book data, audio data, and a variety of information corresponding to user data. The data region stores information related to the DRM contents (DRM_MO) or the license (DRM_RO) as well as video data and audio data, which are related to the DRM contents (DRM_MO). In other words, the DRM content information (detail_Info) includes information defining the DRM contents (DRM_MO) and information related to the license (DRM_RO). In other words, the DRM content information (detail_Info) includes a variety of information, such as total file size, file type, detailed file names, and the file reproducing time of the DRM contents (DRM_MO), content-related information, and rights of the DRM contents that limit content reproduction, etc. Also, the DRM content information (detail_Info) includes purchase information including a purchase price, the purchase site, and purchase method, etc., and authority limit information defined in the license (DRM_RO), etc. When the DRM controller (DRM_MO) is displayed in a list, the DRM content information (detail_Info) is transmitted from an external device or the memory 150 to the control unit 160, according to a user's selection, to display a part or all thereof. Storing and displaying operations of the DRM content information (detail_Info) will be described in detail later.

Still referring to FIG. 2, the key input unit 140 inputs figure and letter information and is configured to include a plurality of input keys and function keys, which are used to set a variety of functions. The functions keys include direction keys, side keys, and hot keys, etc., which are set to execute a specific function. Also, the key input unit 140 transmits key signals, related to a user's setting and control of the portable terminal 100, to the control unit 160.

In particular, the key input unit 140 creates a key signal designating one of the DRM contents (DRM_MO) displayed in a list on the display 120 and then transmits it to the control unit 160. Also, the key input unit 140 creates a key signal for selecting the designated DRM contents (DRM_MO) and then transmits it to the control unit 160. Here, to “designate” means to indicate one of the DRM contents (DRM_MO) displayed in a plurality of lists. The indicated DRM contents (DRM_MO) are displayed in such a way to be distinguishable from peripheral items. That is, the indicated DRM contents (DRM_MO) can be displayed by highlighting or focusing. Additionally, “selection” means an input to execute the “indicated” DRM contents (DRM_MO). The designation can also be moved according to an input of the direction key, numeric key, and/or special key, etc. For example, when a key used for a movement operation is activated to designate one of the DRM contents (DRM_MO), items currently designated through highlighting and focusing are designated to other items.

The audio processing unit 130 reproduces audio signals for a call, such as a voice, through a speaker, or transmits audio signals, (such as a voice) inputted through a microphone MIC to the control unit 160. In particular, the audio processing unit 130 of the present invention reproduces audio components included in the DRM contents (DRM_MO). Also, when audio components are not included in the DRM content information (detail_Info), the audio processing unit 130 may reproduce the audio components according to a user's selection.

The control unit 160 controls the entire operation of the portable terminal 100, which includes signaling flow between elements of the portable terminal 100. The control unit 160 includes a modem and a codec, which process data stored in the memory 150, as well as calling sound and data, etc., received by the radio frequency unit 110.

In particular, the control unit 160 controls a function related to displaying control according to the menu screen display and selection, to display DRM content information (detail_Info). When a key input signal is inputted to view a list of DRM contents (DRM_MO) stored in the memory 150, the control unit 160 controls the display of the list on the display 120. Here, the control unit 160 controls the downloading of the DRM content information (detail_Info) from the contents providing server 200. That is, the control unit 160 extracts address information included in each of DRM contents (DRM_MO), for example, a uniform resource locator (URL) or Internet protocol (IP) address, etc., and uses the URL or IP address to receive the DRM content information (detail_Info). Here, the control unit 160 may extract a part or all of the address information of the DRM contents (DRM_MO) to use it. Next, the control unit 160 controls the creation of a channel to communicate with the contents providing server 200, using the address information of the extracted DRM contents (DRM_MO).

After that, the control unit 160 creates an information request message (data_req) that requests DRM content information (detail_Info) of the DRM contents (DRM_MO). The control unit 160 transmits the information request message (data_req) to the contents providing server 200 and controls the radio frequency unit 110 to receive corresponding DRM content information (detail_Info). In addition, the control unit 160 extracts address information of the total DRM contents (DRM_MO) stored in the memory 150 or address information of the total DRM contents (DM_MO) displayed on the display 120, and then stores it in the memory 150. The control unit 160 controls to display the DRM content information (detail_Info) downloaded from the contents providing server 200 on an area in which corresponding DRM contents (DRM_MO) are displayed. Here, the contents providing server 200 downloading the DRM content information (detail_Info) may be different from it.

The control unit 160 extracts the address information of designated DRM contents of the displayed DRM contents (DRM_MO) and address information of DRM contents adjacently arrayed to the designated DRM contents. That is, the control unit 160 extracts address information of DRM contents adjacently arrayed to the designated DRM contents, to more rapidly acquire DRM content information (detail_Info) that correspond to the DRM contents (DRM_MO) that are changed according to an input signal of the key input unit 140, and then stores same in the memory 150. The control unit 160 does not extract the address information of the DRM contents (DRM_MO) whose designation may be changed in the designation process, but extracts the address information before designation for storage in the memory. When the designated DRM contents is changed in response to an input signal of the key input unit 140, the control unit 160 can receive corresponding DRM content information (detail_Info) from the contents providing server 200, using the extracted address information.

Still referring to FIG. 2, the control unit 160 commands the display unit 120 to display the received DRM content information (detail_Info) in a text or image format. Additionally, the control unit 160 displays DRM content information having a plurality of information based on items and then controls to display other items once a certain time elapses. The items are the displayed items on a display unit when displaying DRM contents on a display unit that may include a plurality of DRM contents information.

When DRM contents (DRM_MO) are designated, the control unit 160 can display DRM content information (detail_Info) for the designated DRM contents in a bubble text format.

Although the exemplary embodiment of the present invention depicts components in FIG. 2 for explanatory purposes, it will be easily appreciated that the present invention is not limited to these components. For example, the portable terminal 100 of the present invention may further include a camera and/or a digital broadcasting module, etc. as desired. Also, there could be different components, some of which perform some of the functions discussed in the foregoing description of the example illustrated in FIG. 2.

The foregoing is a description of the configuration of the present invention for displaying the DRM contents (DRM_MO) and the DRM content information (detail_Info).

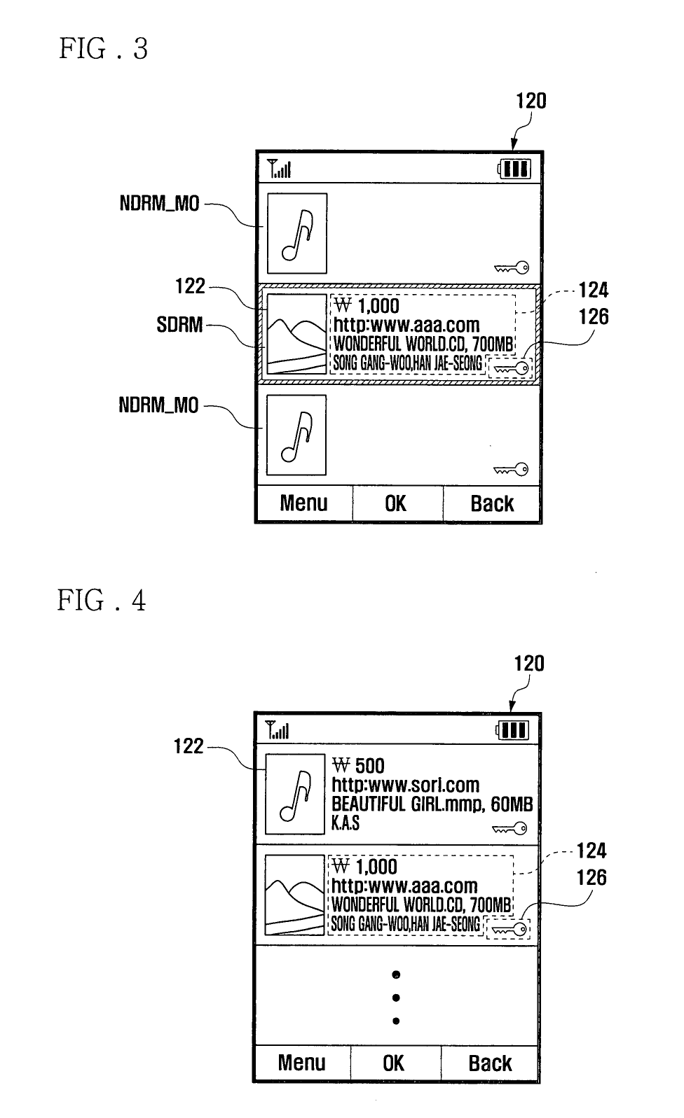

The following is an explanatory description of display screen interfaces according to another example of the present invention, with regard to FIGS. 3 and 4.

FIG. 3 shows a display screen displaying DRM content information (detail_Info) according to an exemplary embodiment of the present invention.

Although the present invention will describe DRM content information (detail_Info) that is displayed in a text format, it is not limited by such a display format. In other words, each item corresponding to the DRM content information (detail_Info) of the present invention will be replaced with a specific image. For example, when displaying a reproduced authority limit, the DRM content information (detail_Info) is displayed by initials corresponding to the reproduced authority limit and an image corresponding to the rest of the reproduced authority limit.

Referring to FIG. 3, the display 120 of the present invention displays DRM contents (DRM_MO) in a list. Although the example shown in FIG. 3 is implemented in such a way that three DRM contents (DRM_MO) are displayed on the display 120, a person of ordinary skill in the art appreciates that the present invention is not limited to the number, type, or layout shown by the exemplary embodiment. That is, the display 120 of the present invention may display the DRM contents (DRM_MO) in a list or in a matrix format, and also displays DRM contents (DRM_MO), which were not currently displayed on the displays 120, as a direction key of the key input unit 140 is inputted or scrolling is performed. The DRM contents (DRM_MO) are displayed on the display 120 through an icon region 122, a DRM content information display region 124, and a DRM display region 126. The items could be arranged in any desired layout on the display, as desired.

The icon region 122 refers to a region displaying an image showing features of the DRM contents (DRM_MO), for example, audio contents, video contents or text contents. When the displayed DRM contents (DRM_MO) are audio contents, the icon region 122 displays a specific image, for example, a musical scale image. When the displayed DRM contents (DRM_MO) are video contents, the icon region 122 displays a specific image, for example, a representative screen of contents. When the displayed DRM contents (DRM_MO) are text contents, the icon region 122 displays an image indicative of a file type of text, i.e., a text file name. It is to be understood that other types of representative icons both can be substituted for those shown in FIG. 3 and according to different and/or for future/additional types of content.

The DRM display region 126 refers to a region indicating whether the contents identified on the list are DRM contents. To this end, the DRM display region 126 may display a specific icon, for example, a key-shaped icon.

The DRM content information display region 124 refers to a region displaying DRM content information (detail_Info). The DRM content information display region 124 displays the DRM content information (detail_Info) in a total display manner, a sliding manner, a bubble text manner, a periodically displaying manner, an available-icon displaying manner, and a key input based displaying manner, and so on. The DRM content information (detail_Info) refers to information corresponding to specific DRM contents designated on the display 120, i.e., designated DRM contents (SDRM_MO). Here, the control unit 160 extracts address information of the designated DRM contents (SDRM_MO), receives corresponding DRM content information (detail_Info) from the contents providing server 200 based on the extracted address information, and provides same to the display 120. It is preferable, but not required, that the control unit 160 extracts address information of adjacent DRM contents (NDRM_MO) adjacently arrayed to the designated DRM content information (detail_Info) and then stores it. That is, since the designated DRM contents (SDRM_MO) can be changed according to an input signal of the key input unit 140, the control unit 160 extracts the address information of the adjacent DRM contents (NDRM_MO) and stores it to display the DRM content information (detail_Info) in real time. Also, the control unit 160 downloads corresponding DRM content information (detail_Info) based on the address information of the adjacent DRM contents (NDRM_MO) and then stores it in the memory 150. And, the control unit 160 may control to load corresponding DRM content information (detail_Info) from the memory 150 according to a change of the designated DRM contents (SDRM_MO) and then to display it on the display 120.

FIG. 4 shows a display screen displaying DRM content information (detail_Info), based in a total displaying manner, according to another exemplary embodiment of the present invention.

Referring to FIG. 4, the DRM content information display region 124 simultaneously displays a plurality of items regarding DRM content information, which are included in the DRM content information (detail_Info), in the respective DRM contents (DRM_MO). That is, the DRM content information display region 124 displays DRM content information (detail_Info) in all the regions of DRM contents (DRM_MO), which are displayed on the display 120, regardless of a user's designation, or DRM content information (detail_Info), which corresponds to the respective DRM contents (DRM_MO) stored in the memory 150, on the display 120.

In detail, the control unit 160 extracts address information of DRM contents (DRM_MO) from the total of DRM contents (DRM_MO) stored in the memory 150. Or the control unit 160 extracts address information of DRM contents (DRM_MO) from the total of DRM contents (DRM_MO) displayed on the display 120. The control unit 160 accesses corresponding contents providing server 200 based on the extracted address information. The control unit 160 then typically downloads corresponding DRM content information (detail_Info) from the contents providing server 200, respectively, and then stores the information in the memory 150. Here, the control unit 160 transmits the downloaded DRM content information (detail_Info) to the display 120 with a command to display a least a portion of the corresponding DRM contents (DRM_MO). Therefore, the display 120 can typically display the DRM content information (detail_Info) in the regions displaying corresponding DRM contents (DRM_MO), respectively.

Still referring to FIG. 4, the control unit 160 provides command and control functions to create and display images corresponding to the respective items of the DRM content information, i.e., icons. That is, the control unit 160 arrays and displays the icons corresponding to the text displayed on the DRM content information display region 124. Here, when the item information corresponding to the respective icons is related to a license, the control unit 160 may visually display the rest of the authority limit through a bar, etc.

In other words, the control unit 160 controls to display how much of the authority limit remains. The control unit 160 displays limit of license (DRM_RO) of the DRM contents (DRM_MO) in such a way that, the larger the bar indicative of the authority limit the longer the length or the number of times of the authority limit and the smaller the bar the shorter the length or the number of times of the authority limit.

The foregoing has described exemplary configurations of the real-time detail information display system of DRM contents and the portable terminal, according to some of the ways the present invention can be practiced.

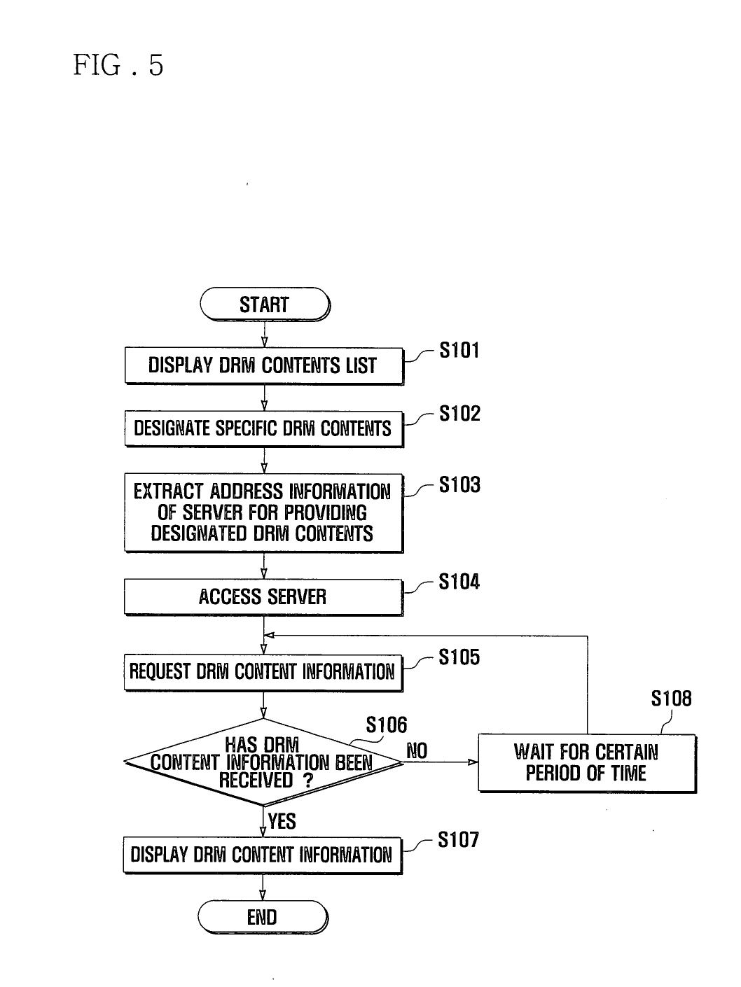

The following is a description of a real-time detail information display method of DRM contents referring to the drawings with reference to the example in FIG. 5.

FIG. 5 comprises a flow chart illustrating one exemplary embodiment of a real-time detail information display method of DRM contents according to the present invention. The control unit 160 displays DRM contents (DRM_MO) stored in the memory 150 in a list in response to a terminal user's request (S101). That is, the control unit 160 provides controls for commanding the display 120 to display a screen interface showing a list of the DRM contents (DRM_MO) according to an input signal through a menu and a hot key.

For example, when the DRM contents (DRM_MO) are composed of MP3 sound sources, the control unit 160 inputs a hot key for driving an MP3 player and displays a list of the DRM contents (DRM_MO) on a display screen. Here, the control unit 160 may display the DRM contents (DRM_MO) in a matrix format, if desired.

Next, the control unit 160 designates a specific DRM contents (DRM_MO) in response to the input signal of the key input unit 140 (S102). After displaying the list of DRM contents (DRM_MO) stored in the memory 150, the control unit 160 may designate an item of DRM contents (DRM_MO) as a default item, which is arrayed on the first line of the display 120. The designated DRM contents (SDRM_MO) may be changed in response to a key input signal corresponding to a movement key of the key input unit 140.

When the DRM contents (DRM_MO) are designated, the control unit 160 extracts address information from the designated DRM contents (SDRM_MO) (S103). The control unit 160 acquires a URL or an IP address from the DRM contents (DRM_MO), which allows access to the contents providing server 200 that is providing the DRM contents (DRM_MO). The DRM contents (DRM_MO) typically includes the address information of the contents providing server 200. In particular, the address information is typically included in the header information of the DRM contents (DRM_MO). Therefore, the control unit 160 checks the DRM contents (DRM_MO) to extract the address information of the contents providing server 200. Also, the address information may be recorded in the license (DRM_RO). Therefore, when the DRM contents (DRM_MO) do not have additional address information therein, the control unit 160 checks the license (DRM_RO) corresponding to the DRM contents (DRM_MO) and then extracts the address information.

Next, the control unit 160 accesses a corresponding contents providing server 200 (S104), based on the address information extracted in S103. Here, it is preferable that the control unit 160 creates a communication channel to perform data communication with the contents providing server 200. The communication channel may be created based on an Internet protocol or a wireless access protocol (WAP), etc.

After that, the control unit 160 requests DRM content information (detail_Info) related to the DRM contents (DRM_MO) from the contents providing server 200 (S105). The control unit 160 transmits an information request message (data_req), which request DRM content information (detail_Info), through the communication channel created in S104.

Next, the control unit 160 checks whether the DRM content information (detail_Info) has been received from the contents providing server 200 (S106). When the portable terminal 100 has received the DRM content information (detail_Info) in S106, the control unit 160 displays the received DRM content information (detail_Info) on a region displaying designated DRM contents (SDRM_MO) (S107).

Still referring to step S107, the control unit 160 can display a variety of information included in the DRM content information (detail_Info) in various manners. For example, the control unit 160 can map various items included in the DRM content information (detail_Info) with distinct images. The control unit 160 can mix the images or texts and command a display of same on a region displaying the DRM contents (DRM_MO). Here, the control unit 160 may display the images or texts independently, mixedly, or variously, taking into account the limitations of the display region size of the DRM contents (DRM_MO). The various display methods of the DRM contents (DRM_MO) include a total displaying manner, a sliding manner, a bubble text manner, a periodical displaying manner, an available-icon displaying manner, and a key input based displaying manner, etc., just to name a few different ways the methods may be practiced.

In more detail, the total display manner adjusts the size of the DRM content information (detail_Info) to comply with a region that displays the DRM contents (DRM_MO), thereby displaying the total DRM content information (detail_Info). For example, the sliding manner displays the DRM content information (detail_Info) while slidably replacing some items of the DRM content information (detail_Info). The bubble text manner displays the DRM content information (detail_Info) in such a way that, when a specific DRM contents (DRM_MO) is designated, a bubble text is created in the designated DRM contents (DRM_MO). The periodical displaying manner displays the DRM content information (detail_Info) in such a way that some items of DRM content information (detail_Info) are displayed on a certain region for a certain period of time, and then another items are displayed on the region for another certain period of time, and such processes are repeatedly performed. The available-icon displaying manner displays currently available peripheral devices of the portable terminal 100, for example, a printer, a Bluetooth module, an external output connection port, etc., through icons that are shaped as corresponding devices and labeled with texts accordingly. The key-input-based displaying manner displays the DRM content information (detail_Info) in such a way that initials corresponding to items of the DRM content information (detail_Info) are designated and an item of the DRM content information (detail_Info) is displayed on a region of the DRM contents (DRM_MO) when a key input signal, which corresponds to an initial of the item, is inputted.

In the instance where the portable terminal 100 has not received the DRM content information (detail_Info) (in S106), the control unit 160 waits for a certain period of time (S108), and then proceeds to back to S105 to request the DRM content information.

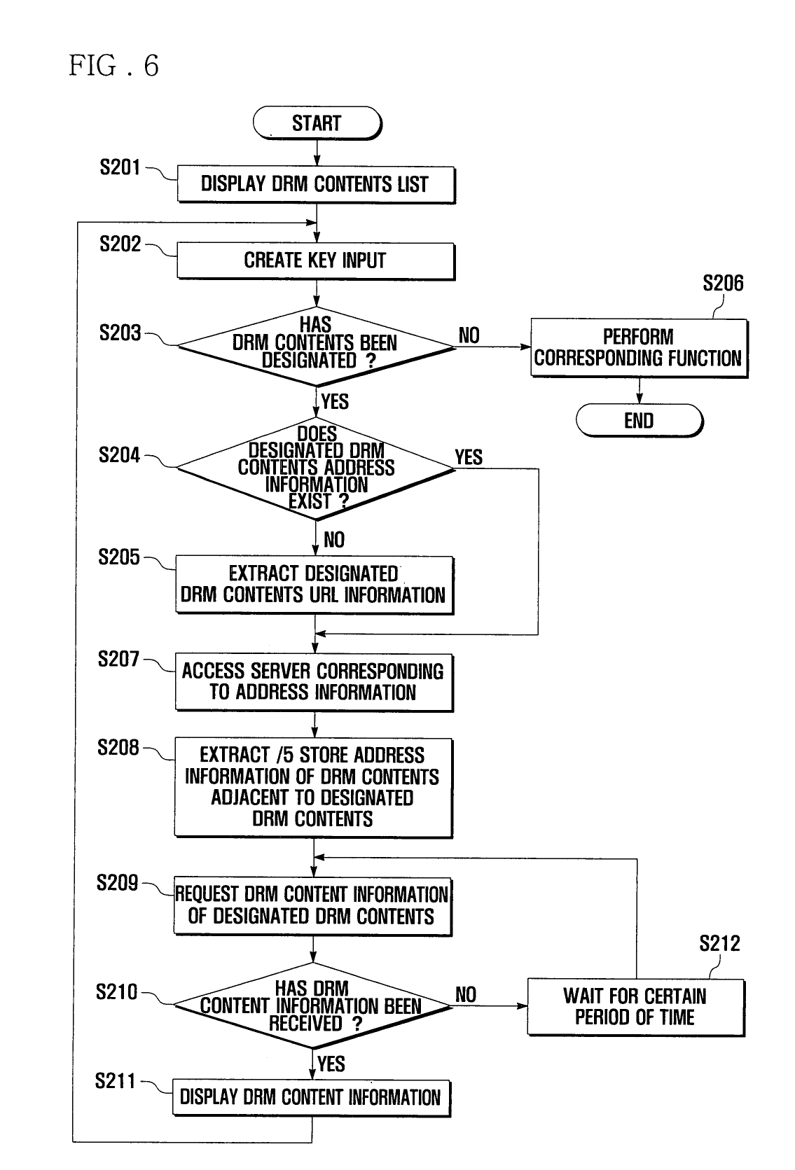

FIG. 6 is a flow chart illustrating another exemplary embodiment of a real-time detail information display method of DRM contents according to the present invention, which can be performed in conjunction with the exemplary schematic shown in FIG. 2.

Referring to FIG. 6, the control unit 160 displays DRM contents (DRM_MO), stored in the memory 150, on a list on a display 120, according to a terminal user's selection (S201). Next, when a key input signal is created (S202), the control unit 160 checks whether the key input signal is a signal designating a specific DRM contents (DRM_MO) (S203). It is preferable that the signal is set to designate the same specific DRM contents (DRM_MO) for a few milliseconds to a few seconds in S203. Note that the present invention is not limited to the range of time.

For example, when the display 120 displays a plurality of DRM contents (DRM_MO) in the search, DRM contents (DRM_MO) that a user did not request may be designated. Therefore, when highlighted and focused DRM contents (DRM_MO) remain highlighted and focused for a certain period of time, it is preferable that they are deemed to be designated.

When the key input signal is a signal designating an item of DRM contents (DRM_MO) in S203, the control unit checks whether address information of the designated DRM contents (SDRM_MO) is stored in the memory 150 (S204). When the address information of the designated DRM contents (SDRM_MO) has not been stored in the memory 150 in S204, the control unit 160 extracts address information from the designated DRM contents (SDRM_MO) (S205). On the other hand, when the address information of the designated DRM contents (SDRM_MO) is stored in the memory 150 in S204, the control unit 160 skips S205.

Next, the control unit 160 accesses the contents providing server 200 (S207), based on the address information, stored in the memory 150, or the extracted address information extracted from the designated DRM contents (SDRM_MO). The address information may be extracted as the header information or the license of the DRM contents (DRM_MO) is checked.

After that, the control unit 160 extracts address information of the DRM control unit adjacently arrayed to the designated DRM contents (SDRM_MO), displayed on the display 120, and then typically stores at least some of the extracted information (S208). The control unit 160 may access a corresponding contents providing server 200 in S208, based on address information stored in the memory 150, which corresponds to the designated DRM contents (SDRM_MO), and address information corresponding to DRM contents adjacent thereto. It is preferable that the control unit 160 performs background processing to assess a server using address information of the DRM contents (DRM_MO) and address information of adjacent DRM contents (NDRM_MO). The background processing is not displayed on the display 120. The background processing refers to work that a terminal requests, such as creation of a specific communication channel, or data reception, etc. Through the works, the portable terminal 100 can maintain various communication routes, i.e., multi session, with the contents providing server 200.

In addition, the adjacently arrayed DRM contents include one or two DRM contents, which are displayed succeeding the designated DRM contents (SDRM_MO), and even DRM contents that are spaced apart from the designated DRM contents (SDRM_MO) at a certain interval according to a designer's setting.

Next, the controller 160 requests DRM content information (detail_Info) of the designated DRM contents (SDRM_MO) from the contents providing server 200 (S209). The control unit 160 creates an information request message (data_req) that requests the DRM content information (detail_Info) from the contents providing server 200. The control unit 160 causes the information request message (data_req) to be transmitted to the contents providing server 200.

Next, the control unit 160 checks whether the DRM content information (detail_Info) is received from the contents providing server 200 (S210). When the portable terminal 100 has received the DRM content information (detail_Info) in S210, the control unit 160 typically displays the received DRM content information (detail_Info) on the display 120 (S211), and then proceeds to S202.

When the portable terminal 100 has not received the DRM content information (detail_Info) in S210, the control unit 160 waits for a certain period of time (S212), and then typically proceeds to S209 after a predetermined time to perform another request of DRM content information of designated DRM contents.

The real-time detail information display method according to the aforementioned exemplary embodiment of the present invention can display the DRM content information (detail_Info) of the designated DRM contents (SDRM_MO), and maintains multi-sessions between the contents providing server 200 and the portable terminal 100 to receive DRM content information (detail_Info) of other DRM contents (DRM_MO) adjacent thereto. Therefore, the real-time detail information display method can receive and display, in real time, the DRM content information (detail_Info) without delaying the extraction of address information from the DRM contents (DRM_MO).

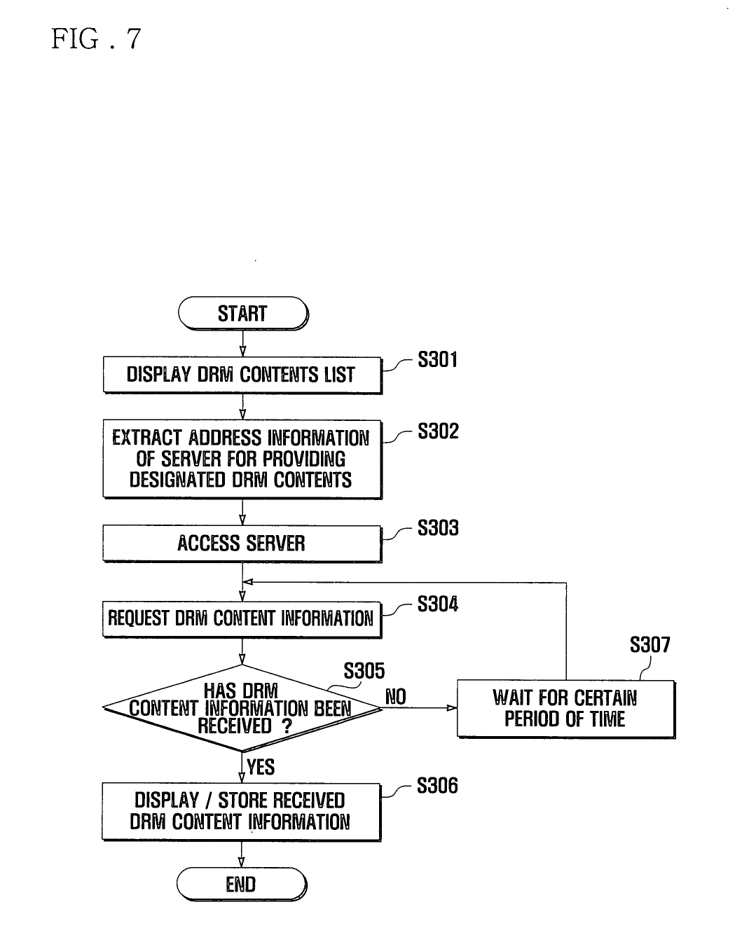

FIG. 7 is a flow chart illustrating another exemplary embodiment of a real-time detail information display method of DRM contents according to the present invention, which can be performed in conjunction with the exemplary schematic shown in FIG. 2. The control unit 160 displays DRM contents (DRM_MO) stored in the memory 150 in a list or in a matrix form according to a terminal user's selection (S301). Next, the control unit 160 extracts the address information of the total DRM contents (DRM_MO), stored in the memory 150, or address information of the total DRM contents (DRM_MO) displayed on the display 120 (S302). It is preferable that the control unit 160 stores the address information of the DRM contents (DRM_MO), displayed on the display 120, and the address information of the all DRM contents (DRM_MO), stored in the memory 150, in a table form.

The control unit 160 accesses corresponding contents providing servers 200 using the extracted address information, respectively (S303). The control unit 160 accesses a corresponding contents providing server 200 using the address information table of the DRM contents (DRM_MO). Here, when the number of contents providing server 200 is plural, or the address information indicates different servers, respectively, the control unit 160 maintains the session for the respective contents providing server 200 and receives the DRM content information (detail_Info) to enhance data reception efficiency.

Next, the control unit 160 requests corresponding contents information (detail_Info) from an accessed contents providing server 200 (S304). The control unit 160 creates respective information request messages (data_req) for requesting the DRM content information (detail_Info), and transmits the information request messages to corresponding contents providing servers 200, respectively.

Next, the control unit 160 checks whether the requested DRM content information (detail_Info) has been received from the respective contents providing servers 200 (S305). When the DRM content information (detail_Info) has been received in S305, the control unit 160 displays the received DRM content information (detail_Info) on the display 120 displaying corresponding DRM contents (DRM_MO), respectively, and stores the received DRM content information (detail_Info) (S306). On the other hand, in S306, the control unit 160 omits the process of storing the DRM content information (detail_Info), and performs only a displaying process of the received DRM content information (detail_Info). When the DRM content information (detail_Info) has not been received in S305, the control unit 160 waits for a certain period of time (S307) and then proceeds to S304 again. It is possible that at least for purposes of display, the information may be temporarily stored in a buffer, which could be a part of the memory unit or a separate unit in communication with the control unit 160 and/or radio frequency unit 110.

The real-time detail information display method according to the aforementioned exemplary embodiment of the present invention extracts address information of the total DRM contents (DRM_MO), displayed on the display 120, or address information of the total DRM contents (DRM_MO) stored in the memory 150, to download all of the corresponding DRM content information (detail_Info). Therefore, the DRM content information (detail_Info) can be displayed on the regions of corresponding DRM contents (DRM_MO), respectively.

As described in the examples above, the real-time detail information display method of DRM contents according to the present invention can simply designates lists of DRM contents (DRM_MO) displayed on the display 120 to acquire DRM content information (detail_Info) of corresponding DRM contents (DRM_MO). Here, the DRM content information (detail_Info), displayed on a region displaying the DRM contents (DRM_MO), is real-time information received from the contents providing server 200.

As described in the foregoing, according to examples of the real-time detail information display method of DRM contents and the portable terminal using the display method, it is easy to acquire the DRM content information in real-time and directly display it on a region displaying the lists of the DRM contents.

Although exemplary embodiments of the present invention have been described in detail hereinabove, it should be understood that many variations and modifications of the basic inventive concept herein described, which may appear to those skilled in the art, will still fall within the sprit of the invention and the scope of the appended claims.

What is claimed is:

1. An information display method of digital rights management (DRM) contents comprising:
displaying a list identifying at least one DRM contents;
extracting at least one piece of address information from the DRM contents identifying an address for requesting at least one DRM contents displayed on the list;
accessing at least one server that provides DRM content information which defines at least one feature of the DRM contents and a license of the associated DRM contents based on the extracted address information;
receiving the DRM content information from the server; and
displaying the received DRM content information on a region displaying corresponding DRM contents.

2. The method of claim 1, further comprising storing the received DRM content information for subsequent display on a region displaying corresponding DRM contents.

3. The method of claim 1, wherein extracting at least one piece of address information comprises extracting address information of all the DRM contents displayed on the list.

4. The method of claim 3, wherein the at least one server comprises a plurality of servers, and the step of accessing servers comprises accessing corresponding servers indicated by the address information of all the DRM contents.

5. The method of claim 1, wherein receiving the DRM content information comprises receiving DRM content information of all the DRM contents.

6. The method of claim 5, further comprising:
storing all the received DRM content information in a memory unit.

7. The method of claim 5, wherein displaying the received DRM content information comprises displaying all the received DRM content information in a corresponding DRM contents display region.

8. The method of claim 5, wherein displaying the received DRM content information comprises displaying only DRM content information of all the received DRM content information, which corresponds to DRM contents that are designated on a display.

9. The method of claim 5, wherein displaying the received DRM content information comprises at least one of:
displaying all items included in the DRM content information;
slidably displaying parts of the items included in the DRM content information;
alternately, displaying some items included in the DRM content information and other items, based on a certain period of time; and
displaying an icon including at least one of an image or a text for an item corresponding to a currently available function of the DRM content information.

10. The method of claim 1, wherein extracting at least one piece of address information comprises extracting address information of DRM contents of the DRM contents displayed on the list, which are designated by a key input signal.

11. The method of claim 10, wherein extracting at least one piece of address information comprises extracting address information of at least one adjacent DRM contents adjacently arrayed to the designated DRM contents.

12. The method of claim 11, wherein the at least one server comprises a plurality of servers, and the step of accessing servers comprises:
accessing a corresponding server based on address information of the designated DRM contents; and
accessing a corresponding server based on address information of the adjacent DRM contents.

13. The method of claim 11, wherein receiving the DRM content information comprises receiving only DRM content information corresponding to the designated DRM contents.

14. The method of claim 13, wherein further comprises displaying the received DRM content information on a region displaying corresponding DRM contents, wherein only the DRM content information of the designated DRM contents is displayed.

15. The method of claim 14, wherein displaying the received DRM content information comprises at least one of:
displaying all items included in the DRM content information;
slidably displaying parts of the items included in the DRM content information;
securing an additional display region in a bubble form in designated DRM contents, and displaying an item included in the DRM content information in the additional display region;
alternately, displaying some items included in the DRM content information and other items, based on a certain period of time;
displaying an icon including at least one of an image or a text for an item corresponding to a currently available function of the DRM content information; and
mapping an item included in the DRM content information to a specific initial, and, when a key corresponding to the initial is keyed, displaying the item corresponding to the keyed initials.

16. A portable terminal displaying digital rights management (DRM) contents comprising:
a memory for storing at least one or more DRM contents;
a display for displaying the DRM contents in a list;
a radio frequency unit for receiving DRM content information that defines at least one of the features of the DRM contents identified in the list and of a license of the DRM contents from external devices; and
a control unit for controlling a display of the DRM content information in a region displaying corresponding DRM contents.

17. The portable terminal of claim 16, wherein the control unit extracts address information of all the DRM contents stored in the memory and accesses a server providing the DRM content information based on the extracted address information.

18. The portable terminal of claim 17, wherein the control unit creates multi-sessions with the server and receives the DRM content information using the respective sessions.

19. The portable terminal of claim 18, wherein the display displays the DRM content information according to at least one of:
displaying all items included in the DRM content information;
slidably displaying parts of the items included in the DRM content information;
alternately, displaying some items included in the DRM content information and other items, based on a certain period of time; and
displaying an icon including at least one of an image or a text for an item corresponding to a currently available function of the DRM content information.

20. The portable terminal of claim 16, wherein the control unit extracts address information of designated DRM contents of the DRM contents displayed on the display and accesses a corresponding server using the extracted address information.

21. The portable terminal of claim 20, wherein the control unit further extracts address information of at least one item of DRM contents arrayed adjacently to the designated DRM contents, and accesses a corresponding server using the address information of the adjacent DRM contents.

22. The portable terminal of claim 21, wherein the control unit receives only DRM content information corresponding to the designated DRM contents.

23. The portable terminal of claim 22, wherein the display displays only the DRM content information in a display region of the designated DRM contents.

24. The portable terminal of claim 23, wherein the display is configured to display the DRM content information according to at least one of:
displaying all items included in the DRM content information;
slidably displaying parts of the items included in the DRM content information;
securing an additional display region in a bubble form in a designated DRM content, and displaying an item included in the DRM content information in the additional display region;
alternately displaying some items included in the DRM content information and other items, based on a certain period of time;
displaying an icon including at least one of an image or a text for an item corresponding to a currently available function of the DRM content information; and
mapping an item included in the DRM content information onto a specific initial, and, when a key corresponding to the initial is keyed, displaying the item corresponding to the keyed initials.
